(19) United States
(12) Patent Application Publication
(10) Pub. No.: US 2016/0257416 A1
(43) Pub. Date: Sep. 8, 2016

(54) PROPULSION SYSTEM

(71) Applicant: Hamilton Sundstrand Corporation, Charlotte, NC (US)

(72) Inventors: Richard A. Himmelmann, Beloit, WI (US); Robert H. Perkinson, Stonington, CT (US); Stephen E. Tongue, Hampden, MA (US)

(21) Appl. No.: 14/475,146

(22) Filed: Sep. 2, 2014

(51) Int. Cl. B64D 27/02

(52) U.S. Cl. CPC B64D 27/02; B64D 2027/026

(57) ABSTRACT

A propulsion system and related methods are disclosed. A propulsion system may have a propulsor, an energy conversion system, an energy storage system that stores electrical energy, and a turbine. The propulsor may be in electrical communication with the energy conversion system, and the energy conversion system may receive electrical energy from the turbine or the energy storage system and deliver it to the propulsor. In this manner, a vehicle may be propelled by the propulsor even when the turbine is not operating.

### FIELD

The present invention relates to the field of propulsion systems, and more specifically, cross-redundant hybrid electric pulsed power propulsion systems for aircraft.

### BACKGROUND

In aircraft propulsion systems, a turbine often provides thrust, for example, via a propulsor such as a turbofan. However, a turbine becomes inefficient when operated at intermediate throttle settings. Moreover, often the aircraft has a separate auxiliary power unit and/or a generator to provide electrical power, but these additional systems increase the weight of the aircraft.

### SUMMARY OF THE INVENTION

A method of operating a propulsion system is provided. The method may include propulsing a vehicle by a propulsor powered by an energy storage system, depleting energy stored in the energy storage system in response to the propulsing, pulsing on a turbine whereby energy may be provided to the energy storage system, replenishing, by the turbine, the energy stored in the energy storage system, and pulsing off the turbine in response to the replenishing.

A propulsion system is provided. The propulsion system may include a first propulsor, a first energy conversion system, a first energy storage system, and a first turbine. The first propulsor may be in electrical communication with the first energy conversion system. The first energy conversion system may receive an energy storage system electrical energy from the first energy storage system and may provide a conditioned energy storage system electrical energy to at least one of the first propulsor and an emergency system.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a block diagram of an example propulsion system having an energy storage system, in accordance with various embodiments;

FIG. 2 illustrates a block diagram of an example of two propulsion systems each having an energy storage system, and joined together by an interconnection element, in accordance with various embodiments;

FIG. 3 illustrates various components of an example propulsion system having an energy storage system, in accordance with various embodiments;

FIG. 4 illustrates various components of an example of two propulsion systems each having an energy storage system, and joined together by an interconnection element, in accordance with various embodiments;

FIGS. 5A-B illustrate example propulsors according to various embodiments;

FIG. 6 illustrates a block diagram of an example propulsion system having an energy storage system and two propulsors joined together by an interconnection element, in accordance with various embodiments; and

FIG. 7 illustrates an example method of operating a propulsion system, in accordance with various embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for manufacturing and construction may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical method of construction.

In various embodiments, an aircraft may comprise a propulsion system. The propulsion system may include a turbine engine. Often, however, turbine engines are inefficient when operated at intermediate throttle settings. During different phases of flight, the turbine may be desired to operate at intermediate throttle settings, decreasing the efficiency of energy consumption. This raises the cost of operating the aircraft because the fuel is not utilized as efficiently at intermediate throttle settings as at a maximal or near maximal efficiency point, such as wide-open throttle or another designed maximal or near maximal efficiency point.

As disclosed herein, one manner of addressing these inefficiencies includes implementing an energy storage system that can receive energy from the turbine and store it for later use. At phases of flight during which the turbine would ordinarily be called on to operate at an intermediate throttle setting, instead, the turbine may be shut down, and the energy storage system may provide stored energy to a propulsor, so that the aircraft can be propelled without a need for the turbine to be running. In this manner, the turbine may be said to be pulsed. Specifically, at times when the turbine would otherwise be called on to operate in a less than optimally efficient manner, rather than utilizing the turbine, stored energy may be used to propel the aircraft instead.

Furthermore, aircraft may include multiple propulsors. For example, a twin-engine aircraft may have a turbine for each wing. The energy storage system can be connected in such a manner that it may store energy from either turbine. Thus, further efficiency gains may be realized by only operating a single turbine to charge the energy storage system. Still furthermore, the need for an aircraft auxiliary power unit may be eliminated by drawing aircraft electrical power from the energy storage system. Furthermore, the need for an emergency ram air turbine may be eliminated. For example, during a turbine failure, the turbine and/or propulsors may be permitted to windmill in response to passing air. The kinetic energy of the windmilling turbine and/or propulsors may be stored in an energy storage system, where it may be drawn by emergency systems, such as emergency hydraulic systems, or by engine re-starter systems, or emergency electrical systems, such as emergency communications systems, or by any other suitable aircraft system.

Furthermore, when the aircraft is on the ground, it may be plugged into the airport electrical grid to recharge the energy storage system. As the aircraft is pushed back and taxiing, energy may be flowed from the energy storage system to the other aircraft systems, such as electrical systems, avionics systems and/or the aircraft propulsors. Thus, the turbines may be left off during ground operations. The turbines may be started for takeoff and climb, and may be utilized to also recharge the energy storage system. During cruise, the turbines may be turned off and the energy storage system may provide energy for the propulsors. One or more turbines may be restarted as needed to recharge the energy storage system. Thus, in addition to saving the fuel burned by not operating the turbine at non-optimal power settings, the aircraft auxiliary power unit may be eliminated and the electrical power for other aircraft systems can provided by the energy storage system.

Furthermore, in the event that all turbines fail during flight, energy can be drawn from the energy storage system to provide emergency electrical power to the other aircraft systems. If the energy from the energy storage system becomes depleted, the aircraft propulsors may be permitted to windmill, causing the propulsors to act as generators, recharging the energy storage system. In this manner, the ram air turbine may be eliminated, as well as its cost, mass, and maintenance issues.

Consequently, one may appreciate that one or multiple propulsions systems may be implemented and may be interconnected. The system may store energy and may release energy, permitting the turbine to avoid operation in inefficient ranges, as well as eliminating heavy and/or costly auxiliary power units and/or emergency ram air turbines.

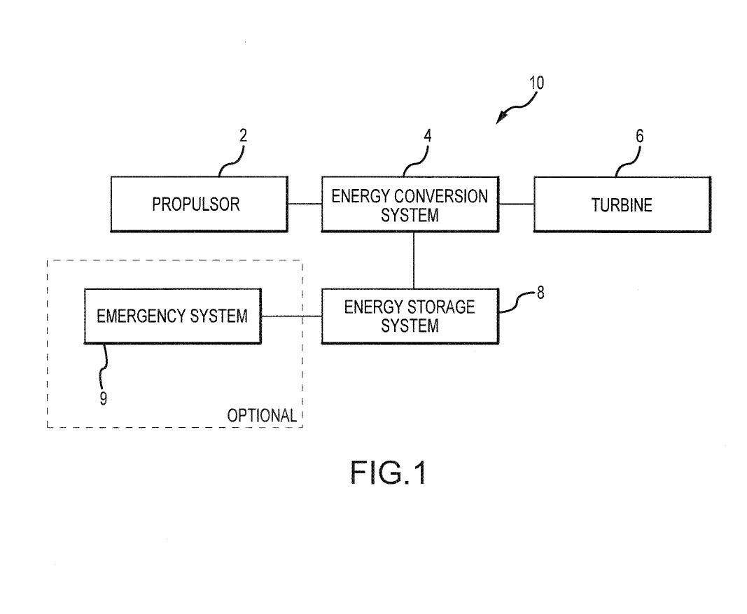

With reference now to FIG. 1, a propulsion system 10 may comprise a propulsor 2, an energy conversion system 4, a turbine 6, and an energy storage system 8. The propulsion system may further comprise an emergency system 9. The propulsion system may accept energy from the turbine 6 and convert it via energy conversion system 4 to a form suited to drive the propulsor 2 and/or for storage in the energy storage system 8.

In various embodiments, the propulsor 2 comprises a kinetic energy imparting apparatus. For example, the propulsor may comprise a propeller system driven by an electrical motor. In various embodiments, the propulsor may also comprise a gear reduction apparatus disposed between the propeller system and the electrical motor, whereby the electrical motor drives the propeller system. The propulsor may receive electrical energy from an energy conversion system 4 and may utilize it to turn an electrical motor, thus turning a propeller. In various embodiments, the propulsor may comprise a propeller, or may comprise a ducted fan, or may comprise any mechanism by which thrust may be imparted to an airframe. The propulsor may provide a further mechanism for the sourcing of energy, such as to eliminate the need for an emergency ram air turbine, or otherwise to provide energy to the energy conversion system. For example, the propulsor may be permitted to windmill in response to passing air. The kinetic energy of the windmilling propulsor may be stored in an energy storage system, where it may be drawn by emergency system 9, such as emergency hydraulic systems, or by engine re-starter systems, or emergency electrical systems, such as emergency communications systems, or by any other suitable aircraft system.

In various embodiments, the energy conversion system 4 comprises a mechanical to electrical energy converting apparatus. For example, the energy conversion system 4 may receive mechanical energy from a turbine 6 via a rotating shaft and may convert this energy into electricity, such as by a generator. In various embodiments, the energy conversion system 4 directs this electrical energy to a propulsor 2, or to an energy storage system 8, or to both a propulsor 2 and to an energy storage system 8. In various embodiments, the energy conversion system 4 may receive electrical energy from an energy storage system 8 and convey it to a propulsor 2. Thus, the energy conversion system 4 may also pass through electrical energy from an energy storage system 8 to a propulsor 2, although it may also convert electrical energy among different voltages, waveforms, currents, phases, or other forms. The energy conversion system 4 may further receive electrical energy from an energy storage system 8 and convey it to a turbine 6. For example, in the event that the turbine needs to be started, the energy conversion system 4 may receive electrical energy from the energy storage system 8, convert it to mechanical energy, such as by a motor (e.g., a generator run in reverse), and deliver it to the turbine 6 via a rotating shaft, such as for restarting the turbine.

In various embodiments, the energy storage system 8 comprises an electrical energy storing apparatus. For example, the energy storage system 8 may comprise one or more batteries. The energy storage system 8 may receive electrical energy from an energy conversion system 4 and may store it. Furthermore, the energy storage system 8 may deliver electrical energy to an energy conversion system 4, for ultimate delivery to a propulsor 2, or for conversion to mechanical energy and delivery to a turbine 6, such as for restarting the turbine 6.

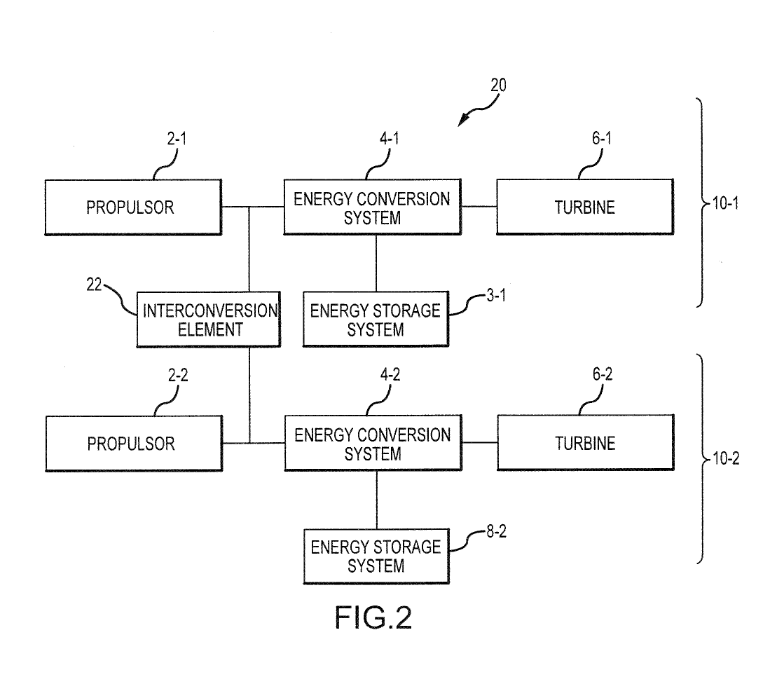

With reference to FIG. 2, multiple propulsion systems 10 may be interconnected.

For example, an interconnected propulsion system 20 may comprise a first propulsion system 10-1 and a second propulsion system 10-2. The first propulsion system 10-1 may comprise a first energy conversion system 4-1, a first turbine 6-1, a first energy storage system 8-1 and a first propulsor 2-1 interconnected as discussed herein. Similarly, the second propulsion system 10-2 may comprise a second energy conversion system 4-2, a second turbine 6-2, a second energy storage system 8-2, and a second propulsor 2-2 interconnected as discussed herein.

An interconnected propulsion system 20 may further comprise an interconnection element 22. An interconnection element 22 may comprise electrical wiring disposed between the first propulsor 2-1 and the second propulsor 2-2. In this manner, the propulsors may be connected in parallel. Accordingly, either propulsor, and/or both propulsors may receive electrical energy from either energy conversion system, and/or both energy conversion systems. Similarly, either propulsor and/or both propulsors may deliver energy to either energy conversion system and/or both conversion systems. In various embodiments, the interconnection element 22 comprises an interconnection disposed between the first propulsor 2-1 and first energy conversion system 4-1 and connecting between the second propulsor 2-2 and the second energy conversion system 4-2. However, in further embodiments, the interconnection element 22 may be disposed between the energy conversion system and energy storage system, or any other interconnection point in the systems.

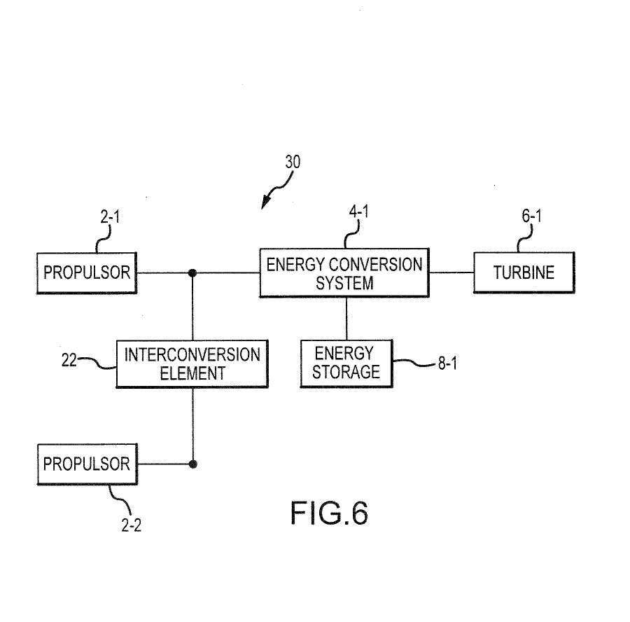

For instance, consider FIG. 6, wherein a dual-propulsor propulsion system 30 is provided. A dual-propulsor propulsion system 30 may comprise a first turbine 6-1, a first energy conversion system 4-1, and a first energy storage system 8-1, arranged as discussed herein. However, a first propulsor 2-1 may be interconnected with the first energy conversion system 4-1, and an interconnection element 22 disposed between the first propulsor 2-1 and the energy conversion system 4-1, whereby the second propulsor 2-2 is also connected to the same first energy conversion system 4-1.

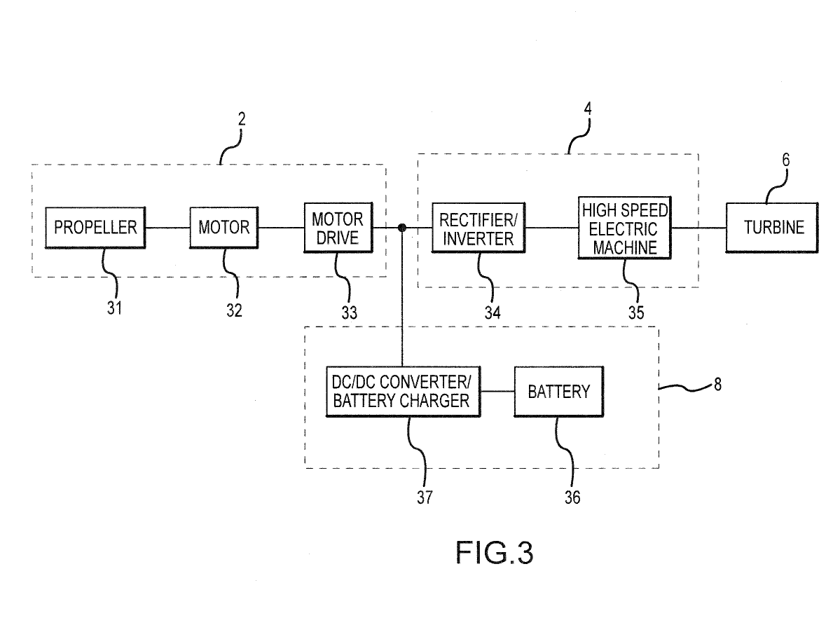

Having discussed various aspects of propulsion systems, with reference to FIG. 3, various aspects of a various details of a propulsion system 10 are provided. A turbine 6 may comprise gas turbine. However, turbine 6 may comprise various supporting systems, such as pumps, gearboxes, valves, and tubing. In various embodiments, the turbine 6 comprises a turbofan engine. In further embodiments, the turbine 6 comprises a turboprop engine, or a turbojet engine, or any other form of turbine engine. In various embodiments, the turbine 6 does not comprise a turbine engine, but comprises a fuel cell. Moreover, in still further embodiments, the turbine 6 does not comprise a turbine engine, but comprises an internal combustion engine, for example, an internal combustion engine having pistons, and/or an internal combustion engine comprising a rotary engine. Alternatively, the turbine 6 may comprise an internal combustion reciprocating engine, such as one based on Otto cycle, or Diesel cycle, or Miller cycle, or Atkinson cycle, or an internal combustion rotary engine (e.g., Wankel), or another internal combustion engine, or an external combustion continuous engine such as a gas turbine engine (based on the open Brayton cycle), or any other engine. Furthermore, the turbine 6 can be an internal combustion engine which is aspirated naturally or with forced induction (e.g., turbo-charged or super-charged). The turbine 6 may have a turbocharger which may be a single or dual (twin) configuration using a centrifugal compressor directly coupled to either an axial inflow or centrifugal inflow turbine, and whose operation may be further enhanced by structures such as: variable vane geometries, articulated waste gates, blow-off/pressure relief valves, and by methods such as: intercooling, water spray injection, etc.

An energy conversion system 4 may comprise a rectifier/inverter 34. A rectifier/inverter 34 may comprise an electrical circuit comprising diodes and/or controllers and/or transistors and/or other electrical components whereby alternating-current electricity, such as that provided by a high-speed electric machine 35 (discussed below) is converted into direct-current electricity (e.g., “rectified”). Similarly, a rectifier/inverter 34 may comprise an electrical circuit comprising diodes and/or controllers and/or transistors and/or other electrical components whereby direct-current electricity, such as that provided by an energy storage system 8 (discussed below) may be converted into alternating-current electricity, such as to drive a high speed electric machine 35 as an electric motor. Thus, the rectifier/inverter 34 conditions electrical energy received from a high-speed electric machine (high speed electric machine electrical energy), conditions electrical energy received from an energy storage system (energy storage system electrical energy), and/or conditions electrical energy received from other sources, such as a windmilling propulsor.

Moreover, an energy conversion system 4 may comprise a high-speed electric machine 35. A high-speed electric machine 35 may comprise an electric motor and/or a generator depending on how it is implemented. For example, a high speed electric machine 35 may operate as a motor in response to electrical current, for example an alternating current being provided, such as by a rectifier/inverter 34. In this manner, the high-speed electric machine 35 may rotate a shaft, which may be mechanically connected to a turbine 6 and which may spin the turbine compressor such as when the turbine is being started. Furthermore, a high-speed electric machine 35 may operate as a generator in response a rotating shaft being spun, such as by a turbine 6. In response, the high-speed electric machine 35 may produce an alternating current that is provided to the rectifier/inverter 34, for rectification into a direct current and utilization by other system(s).

An energy storage system 8 is also discussed in detail. An energy storage system 8 may comprise a battery 36. Battery 36 may comprise a lithium-ion battery, a lithium-ion polymer battery, a lead acid battery, a nickel metal hydride battery, a nickel cadmium battery, a fuel cell, ultra-capacitors, super-capacitors or any other apparatus whereby electrical energy may be stored, for example, a combination of one or more ultra-capacitor and/or super-capacitor and one or more battery.

An energy storage system 8 may further comprise a DC/DC converter/battery charger 37. The DC/DC converter/battery charger 37 may receive electrical energy, such as from a propulsor 2 and/or an energy conversion system 4 and may convert it to a form suitable for storage in the battery 36. For example, the DC/DC converter/battery charger 37 may convert a direct current having a first current and first voltage to a direct current having a second current and second voltage more suitable for storage in the battery 36. Alternatively, the DC/DC converter/battery charger may convert an alternating current to a direct current suitable for storage in the battery. Similarly, the DC/DC converter/battery charger 37 may convert a direct current having a first current and a first voltage as provided by the battery into a direct current having a second current and a second voltage or into an alternating current, for example, for provision to an energy conversion system 4 and/or a propulsor 2. Thus, in this manner, the electrical energy may be transformed to any form suitable for storage in the battery 36 and for utilization by other aircraft systems when drawn from the battery 36.

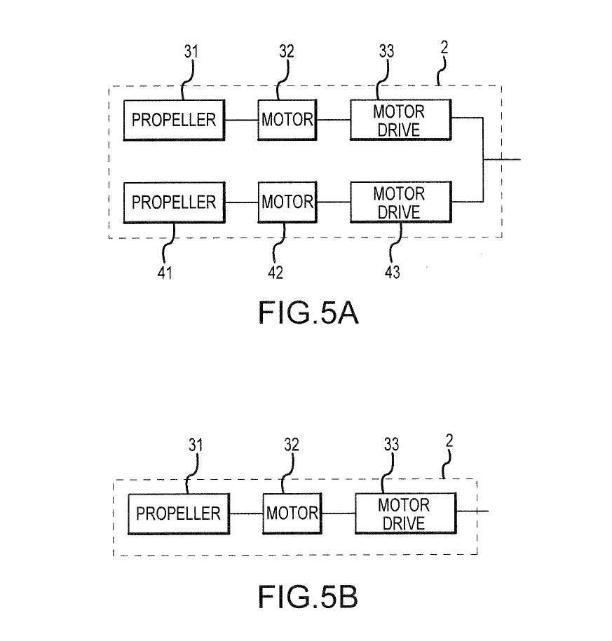

Moreover, a propulsor 2 may further comprise various embodiments. For example, with reference to FIG. 5A and FIG. 5B, a propulsor 2 may comprise different configurations. In various embodiments, with reference to FIGS. 3 and 5B, a propulsor 2 may comprise a motor drive 33, a motor 32, and a propeller 31. The motor drive 33 may receive electrical energy, and provide power and control signals to a motor 32 whereby the motor 32 may be directed to spin a propeller 31 in response.

The motor drive 33 may comprise a three-phase solid-state motor controller. For example, the motor drive 33 may receive electrical energy and provide three-phase alternating current power to the motor, in order to control the speed and direction of the motor. Alternatively, the motor drive 33 may comprise a five-phase solid-state motor controller, such as to drive a switched reluctance motor, or may comprise a six-phase solid-state motor controller, or any number ‘n’ phase motor controller. In various embodiments, the motor drive 33 provides pulse-width modulated power to the motor; however, in further embodiments, the motor drive 33 provides current limited power to the motor. Thus, the motor drive 33 may comprise any architecture suitable for implementation with a desired motor 32.

The motor 32 may comprise brushless motor, such as a three-phase brushless motor, or a five-phase brushless motor, or a six-phase brushless motor, or any number ‘n’ phase motor. The motor 32 may comprise a brushed motor. The motor 32 may comprise a switched reluctance motor. The motor 32 may comprise supporting hardware such as gearboxes, mechanical linkages, shafts, flywheels, etc.

The propeller 31 may comprise a propeller in mechanical connection to the motor 32. The propeller 31 may comprise a constant speed propeller, or a turbofan, or a constant pitch propeller, or a ducted fan, or any other mechanism by which an aircraft may be propulsed. Furthermore, the propeller 31 may comprise additional controllers and/or circuitry, for example, to control propeller pitch and/or speed. In further embodiments, the propeller 31 comprises two blades, or three blades, or four blades, or five blades, or six blades, or any number of blades and/or vanes, for example, in the event that the propeller comprises a ducted fan. The propeller may comprise a housing and/or shroud, or any apparatus whereby airflow may be directed through the blades of the propeller.

With momentary reference to FIG. 5A-B, various aspects a further embodiment of a propulsor 2 are discussed in detail. In various embodiments, a propulsor 2 comprises a single propeller 31, a single motor 32, and a single motor drive 33, as illustrated in FIG. 5B. However, in further embodiments, a propulsor 2 may comprise multiple propellers. For example, with reference to FIG. 5A, a propulsor 2 may comprise a propeller 31 driven by a motor 32 which is controlled by a motor drive 33. However, the propulsor 2 may further comprise a second propeller 41, driven by a second motor 42, which is controlled by a second motor drive 43. For example, a propulsor 2 may comprise two propellers (31, 41) which are counter-rotating.

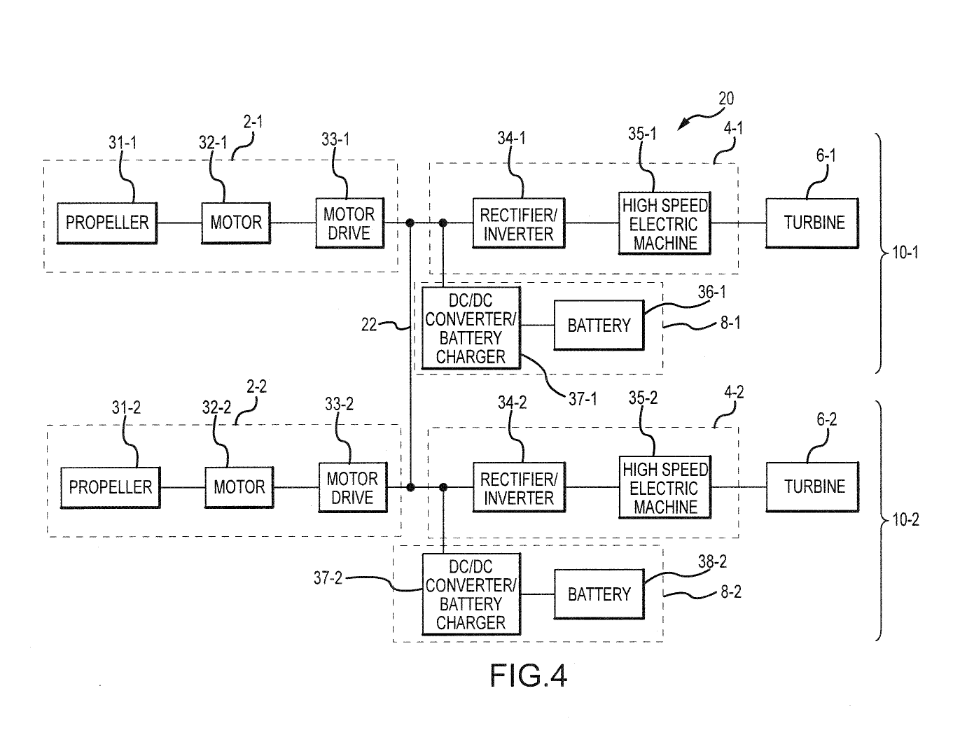

With reference to FIG. 4, one arrangement of an interconnected propulsion system 20 is illustrated in detail. For example, a first propulsion system 10-1 may comprise a first turbine 6-1, a first energy conversion system 4-1, a first energy storage system 8-1, and a first propulsor 2-1. A second propulsion system 10-2 may comprise a second turbine 6-2, a second energy conversion system 4-2, a second energy storage system 8-2, and a second propulsor 2-2. The first propulsion system 10-1 and second propulsion system 10-2 may be interconnected by an interconnection element 22 disposed as illustrated, between the first propulsor 2-1 and first energy conversion system 4-1 and interconnecting between the second propulsor 2-2 and second energy conversion system 4-2.

The first energy conversion system 4-1 may comprise a first energy conversion system high-speed electric machine 35-1 and a first energy conversion system rectifier/inverter 34-1. Similarly, the second energy conversion system 4-2 may comprise a second energy conversion system high-speed electric machine 35-2 and a second energy conversion system rectifier/inverter 34-2.

The first energy storage system 8-1 may comprise a first energy storage system battery 36-1 and a first energy storage system DC/DC converter/battery charger 37-1. Similarly, the second energy storage system 8-2 may comprise a second energy storage system battery 36-2 and a second energy storage system DC/DC converter/battery charger 37-2.

The first propulsor 2-1 may comprise a first propulsor propeller 31-1, a first propulsor motor 32-1 and a first propulsor motor drive 33-1. Similarly, the second propulsor 2-2 may comprise a second propulsor propeller 31-2, a second propulsor motor 32-2 and a second propulsor motor drive 33-2. Moreover, the first propulsor 2-1 and/or second propulsor 2-2 may be configured according to FIG. 5B, as discussed herein.

Thus, as one may appreciate, various aspects of various different embodiments discussed herein may be combined and interchanged. For example, with reference to FIG. 2, an interconnected propulsion system 20 may comprise a first propulsion system 10-1 having a propulsor according to FIG. 5A, and a second propulsion system 10-2 having a propulsor according to FIG. 5B, or also according to FIG. 5A, or comprising any other combination and/or arrangement of elements.

### Method of Operation

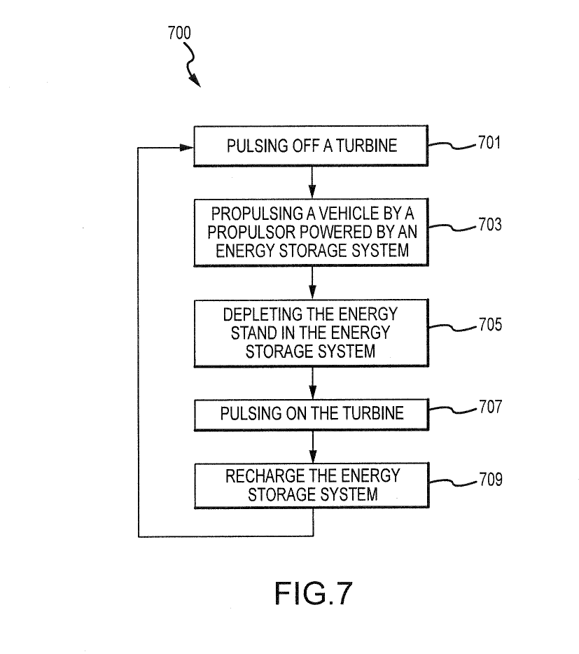

Having discussed various aspects of a propulsion system, a propulsion system may operate according to different methods. For example, with reference to FIG. 7, a method 700 may include pulsing off a turbine (Step 701). This may comprise shutting the turbine down, or may comprise retarding the turbine throttle setting to an idle setting, for example, a flight idle or a ground idle. The method may further include propulsing the aircraft by a propulsor powered by an energy storage system (Step 703). The energy stored within the energy storage system may be depleted (Step 705). Upon the depleting of the energy stored within the energy storage system, the method may include pulsing on the turbine (Step 707). This may include advancing the turbine throttle setting to an optimal efficiency setting. This may further include restarting the turbine. The energy storage system may be recharged (Step 709). Upon completion of the recharging of the energy storage system, the method 700 may then return to step 701 and the turbine may be pulsed off. In this manner, the duty cycle of the turbine is decreased such that the turbine spends less time operating at non-optimal throttle settings.

Having discussed various aspects of a propulsion system, a propulsion system may be made of many different materials or combinations of materials. For example, various components of the system may be made from metal. For example, various aspects of an propulsion system may comprise metal, such as titanium, aluminum, steel, or stainless steel, though it may alternatively comprise numerous other materials configured to provide support, such as, for example, composite, ceramic, plastics, polymers, alloys, glass, binder, epoxy, polyester, acrylic, or any material or combination of materials having desired material properties, such as heat tolerance, strength, stiffness, or weight. In various embodiments, various portions of a propulsion system as disclosed herein are made of different materials or combinations of materials, and/or may comprise coatings.

In various embodiments, a propulsion system may comprise multiple materials, or any material configuration suitable to enhance or reinforce the resiliency and/or support of the system when subjected to wear in an aircraft operating environment or to satisfy other desired electromagnetic, chemical, physical, or material properties, for example radar signature, heat generation, efficiency, electrical output, strength, or heat tolerance.

In various embodiments, various components may comprise an austenitic nickel-chromium-based alloy such as Inconel®, which is available from Special Metals Corporation of New Hartford, N.Y., USA. In various embodiments, various components may comprise ceramic matrix composite (CMC). Moreover, various aspects may comprise refractory metal, for example, an alloy of titanium, for example titanium-zirconium-molybdenum (TZM).

Various fluids such as hydraulic fluid, cooling oils, and fuel may be incorporated into various components. For example, hydraulic fluid may comprise any hydraulic oil or fluid. Moreover, fuel may be a kerosene-type jet fuel such as Jet A, Jet A-1, JP-5, and/or JP-8. Alternatively, fuel may be a wide-cut or naphtha-type jet fuel, such as Jet B and/or JP4. Furthermore, fuel may be a synthetic fuel, such as Fischer-Tropsch Synthetic Paraffinic Kerosene (FT-SPK) fuel, or Bio-Derived Synthetic Paraffinic Kerosene (Bio-SPK), or may be any other suitable fuel, for example, gasoline or diesel.

While the systems described herein have been described in the context of aircraft applications; however, one will appreciate in light of the present disclosure, that the systems described herein may be used in various other applications, for example, different vehicles, such as cars, trucks, busses, trains, boats, and submersible vehicles, space vehicles including manned and unmanned orbital and sub-orbital vehicles, or any other vehicle or device, or in connection with industrial processes, or propulsion systems, or any other system or process having need for propulsion systems.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of operating a propulsion system comprising:
propulsing a vehicle by a propulsor powered by an energy storage system;
depleting energy stored in the energy storage system in response to the propulsing;
pulsing on a turbine whereby energy may be provided to the energy storage system;
replenishing, by the turbine, the energy stored in the energy storage system; and
pulsing off the turbine in response to the replenishing; and
replenishing, by the propulsor, the energy stored in the energy storage system by permitting the propulsor to windmill in response to a turbine failure.

2. The method according to claim 1, wherein the pulsing off comprises retarding a throttle of the turbine to a flight idle position.

3. The method according to claim 1, wherein the pulsing off comprises shutting down the turbine.

4. A propulsion system comprising:
a first propulsor;
a first energy conversion system;
a first energy storage system; and
a first turbine,
wherein the first propulsor is in electrical communication with the first energy conversion system, and wherein the first energy conversion system receives an energy storage system electrical energy from the first energy storage system and provides a conditioned energy storage system electrical energy to at least one of the first propulsor and an emergency system.

5. A propulsion system according to claim 4, wherein the first turbine comprises a gas turbine.

6. The propulsion system according to claim 4, further comprising a second propulsor in electrical communication with the first energy conversion system.

7. The propulsion system according to claim 4, further comprising:
a second propulsor;
a second energy conversion system;
a second energy storage system;
a second turbine; and
an interconnection component comprising electrical wiring between the first propulsor and the first energy conversion system and connecting to between the second propulsor and the second energy conversion system, wherein the second propulsor is in electrical communication with the second energy conversion system, p1 wherein the second energy conversion system receives the energy storage system electrical energy from at least one of: the second energy storage system and the first energy storage system.

8. The propulsion system according to claim 4, wherein the first propulsor further comprises:
a first propeller;
a first electric motor in mechanical communication with the first propeller; and
a first electric motor controller in electrical communication with the first electric motor,
wherein the first electric motor controller directs the first electric motor to spin the first propeller.

9. The propulsion system according to claim 8, wherein the first propulsor further comprises:
a second propeller;
a second electric motor in mechanical communication with the second propeller; and
a second electric motor controller in electrical communication with the second electric motor,
wherein the second electric motor controller directs the second electric motor to spin the second propeller, and
wherein the first propeller and the second propeller counterrotate.

10. The propulsion system according to claim 4, wherein the first propulsor further comprises:
a first ducted fan;
a first electric motor in mechanical communication with the first ducted fan; and
a first electric motor controller in electrical communication with the first electric motor,
wherein the first electric motor controller directs the first electric motor to spin the first ducted fan.

11. The propulsion system according to claim 4, wherein the first energy storage system comprises:
a battery; and
a DC/DC converter/battery charger, wherein electrical energy is conditioned by the DC/DC converter/battery charger prior to storage in the battery, and wherein electrical energy is conditioned by the DC/DC converter/battery charger prior to delivery from the battery to at least one of the first propulsor and the first energy conversion system.

12. The propulsion system according to claim 11, wherein the battery comprises a lithium ion battery.

13. The propulsion system according to claim 4, wherein the first energy conversion system comprises:
a rectifier/inverter; and
a high-speed electric machine,
wherein the high-speed electric machine at least one of:
receives the energy storage system electrical energy from the rectifier/inverter and mechanically rotates the first turbine, and
receives mechanical energy from the first turbine and generates a high-speed electric machine electrical energy communicated to the rectifier/inverter,
wherein the rectifier/inverter at least one of:
conditions the energy storage system electrical energy and delivers the conditioned energy storage system electrical energy to the high-speed electric machine, and
conditions the high-speed electric machine electrical energy and delivers a conditioned high-speed electric machine electrical energy to the first energy storage system.

14. The propulsion system according to claim 13,
wherein the conditioning the energy storage system electrical energy comprises converting the energy storage system electrical energy from direct current to alternating current, and wherein the conditioning the high-speed electric machine electrical energy comprises converting the high-speed electric machine electrical energy from alternating current to direct current.

15. The propulsion system according to claim 4, further comprising:
a second propulsor; and
an interconnection component comprising electrical wiring disposed between the first propulsor and the second propulsor whereby the first propulsor and the second propulsor are connected in parallel.
